(19) United States
(12) Patent Application Publication
(10) Pub. No.: US 2022/0147709 A1
(43) Pub. Date: May 12, 2022

(54) METHOD AND APPARATUS FOR ANALYZING TEXT DATA CAPABLE OF GENERATING DOMAIN-SPECIFIC LANGUAGE RULES

(71) Applicant: MISOINFO Tech., Seoul (KR)

(72) Inventors: Yong Deok Hwang, Seoul (KR); Sangdo Nam, Seoul (KR); Dong Uk An, Seoul (KR); Jin Ho Son, Gyeonggi-do (KR)

(21) Appl. No.: 17/522,099

(22) Filed: Nov. 9, 2021

(30) Foreign Application Priority Data
Nov. 9, 2020 (KR) 10-2020-0148816

(51) Int. Cl. G06F 40/263; G06F 40/30; G06F 40/279; G06F 40/55

(52) U.S. Cl. CPC G06F 40/263; G06F 40/55; G06F 40/279; G06F 40/30

(57) ABSTRACT

Disclosed is a method for analyzing text data, which is performed by a computing device including at least one processor. The method may include: acquiring one or more text data; generating one or more language rules from at least a part of the one or more text data based on concept information; providing a user interface including the one or more generated language rules, and capable of receiving a first user input for the one or more language rules from a user; and generating a language rule set including at least one language rule among the one or more language rules based on the first user input.

### CROSS-REFERENCE TO RELATED APPLICATIONS

This application claims priority to and the benefit of Korean Patent Application No. 10-2020-0148816 filed in the Korean Intellectual Property Office on Nov. 9, 2020, the entire contents of which are incorporated herein by reference.

### TECHNICAL FIELD

The present disclosure relates to a method for analyzing text data, and more particularly, to a method for generating a language rule, and analyzing text data based thereon.

### BACKGROUND ART

In existing art, there have been various methods for analyzing text data. The text data analysis includes various operations such as positive-negative judgment, text subject classification, text summary generation, etc. In recent years, with technological development of machine learning, deep learning, an artificial neural network, etc., technologies for analyzing text data based on a deep learning technique have been emerged even in a natural language processing field.

However, if text data analysis and classification tasks are performed based on an artificial neural network model in the existing natural language processing field, there was a problem that a cause of the text data was finally classified into a specific class. That is, since the artificial neural network model performs a final classification based on weights and deflection values of one or more nodes, there has been a problem that a basis for the classification is unknown. Furthermore, in the case of the artificial neural network model, an intervention of a user is possible only in an initial input or final output phase, retraining of the artificial neural network model is inevitably required for improving a performance of the model, so there was a problem that a lot of time is required for achieving a performance required by a specific user. Accordingly, in the art, there have been continuously demands for a domain specific text data analysis method and a text analysis method in which the user is capable of easily modifying a method.

Korean Patent Application No. “KR10-2020-7007037” discloses Synonym Dictionary Creation Device, Synonym Dictionary Creation Program, and Synonym Dictionary Creation Method.

### SUMMARY OF THE INVENTION

The present disclosure has been made in an effort to provide a method for generating a language rule, and analyzing text data based thereon.

An exemplary embodiment of the present disclosure provides a method for analyzing text data, which is performed by a computing device including at least one processor. The method may include: acquiring one or more text data; generating one or more language rules from at least a part of the one or more text data based on concept information; providing a user interface including the one or more generated language rules, and capable of receiving a first user input for the one or more language rules from a user; and generating a language rule set including at least one language rule among the one or more language rules based on the first user input.

In an alternative exemplary embodiment, the concept information may include one or more concept sets, but the concept set may include one or more similar words.

In an alternative exemplary embodiment, the generating of the one or more language rules may include generating one or more transaction data from the one or more text data based on the concept information, calculating association information for one or more concept set item sets based on the one or more transaction data, and generating one or more language rules based on one or more language functions representing the association information and a linguistic condition.

In an alternative exemplary embodiment, the user interface may include additional information related to the one or more language rules.

In an alternative exemplary embodiment, the additional information may include association information for one or more concept set item sets included in the one or more language rules, or information on a language function which becomes a base for generation of the language rule.

In an alternative exemplary embodiment, the user interface may distinguish and display at least a part of the text data which becomes a base for generating the one or more language rules from another part.

In an alternative exemplary embodiment, the user interface may display the language rule set in a tree structure.

In an alternative exemplary embodiment, the first user input may include binary data for determining whether each language rule included in the one or more generated language rules is to be included in a language rule set, or logical operator data assigned to each language rule when the one or more generated language rules are included in the language rule set.

In an alternative exemplary embodiment, the method may further include generating one or more language rules additionally based on a second user input which is input from a user.

In an alternative exemplary embodiment, the second user input may include a threshold for at least one scale included in the association information, or a factor for at least one language function among the one or more language functions.

Another exemplary embodiment of the present disclosure provides a non-transitory computer-readable medium including a computer program. The computer program executes the following operations for analyzing text data when the computer program is executed by one or more processors, and the operations may include: acquiring one or more text data; generating one or more language rules from at least a part of the one or more text data based on concept information; and generating a language rule set including at least one language rule among the one or more generated language rules based on a first user input which is input from a user.

Still another exemplary embodiment of the present disclosure provides an apparatus for analyzing text data. The apparatus may include: one or more processors; a memory; and a network, in which the one or more processors may be configured to acquire one or more text data, generate one or more language rules from at least a part of the one or more text data based on concept information, and generate a language rule set including at least one language rule among the one or more generated language rules based on a first user input which is input from a user.

According to an exemplary embodiment of the present disclosure, a method for using an interaction with a user for generating a language rule and analyzing text data based thereon can be provided.

### BRIEF DESCRIPTION OF THE DRAWINGS

FIG. 1 is a block diagram of a computing device for analyzing text data according to an exemplary embodiment of the present disclosure.

FIG. 2 is a schematic view illustrating a network function according to an exemplary embodiment of the present disclosure.

FIG. 3 is a flowchart illustrating a process for generating a language rule set according to an exemplary embodiment of the present disclosure.

FIG. 4 is a flowchart illustrating a process for generating a language rule according to an exemplary embodiment of the present disclosure.

FIG. 5 is an exemplary diagram of transaction data generated by a computing device according to an exemplary embodiment of the present disclosure.

FIG. 6 is an exemplary diagram of a user interface according to an exemplary embodiment of the present disclosure.

FIG. 7 is another exemplary diagram of a user interface according to an exemplary embodiment of the present disclosure.

FIG. 8 is still another exemplary diagram of a user interface according to an exemplary embodiment of the present disclosure.

FIG. 9 is a normal and schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

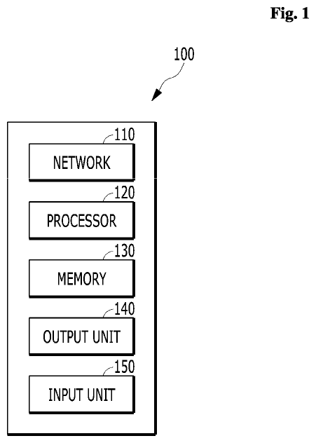

FIG. 1 is a block diagram of a computing device for analyzing text data according to an exemplary embodiment of the present disclosure. A computing device 100 for analyzing text data according to an exemplary embodiment of the present disclosure may include a network 110, a processor 120, a memory 130, an output unit 140, and an input unit 150.

The network 110 may transmit and receive one or more text data according to an exemplary embodiment of the present disclosure to and from other computing devices, servers, and the like. In addition, the network 110 may enable communication among a plurality of computing devices so that operations for analyzing the text data according to the present disclosure is distributively performed in each of the plurality of computing devices.

The network 110 according to an exemplary embodiment of the present disclosure may operate based on arbitrary type wired/wireless communication technology which is currently used and implemented, such as local area (short range), long range, wired, and wireless, and may be used even in other networks.

The processor 120 may be constituted by one or more cores and may include processors for learning a model, which include a central processing unit (CPU), a general purpose graphics processing unit (GPGPU), a tensor processing unit (TPU), and the like of the computing device. The processor 120 may generate one or more language rules from at least some of one or more text data. The processor 120 may also provide, to a user, the one or more generated language rules through the output unit 140 in a form of a user interface. The processor 120 may generate a language rule set including at least one language rule among one or more language rules based on a first user input which is an input of the user for the user interface.

According to an exemplary embodiment of the present disclosure, the memory 130 may store any type of information generated or determined by the processor 120 or any type of information received by the network 110. The memory 130 may store a computer program for analyzing text data according to an exemplary embodiment of the present disclosure and the stored computer program may also be executed by the processor 120.

A database according to an exemplary embodiment of the present disclosure may be the memory 130 included in the computing device 100. Alternatively, the database may be a memory included in a separate server or computing device linked with the computing device 100.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

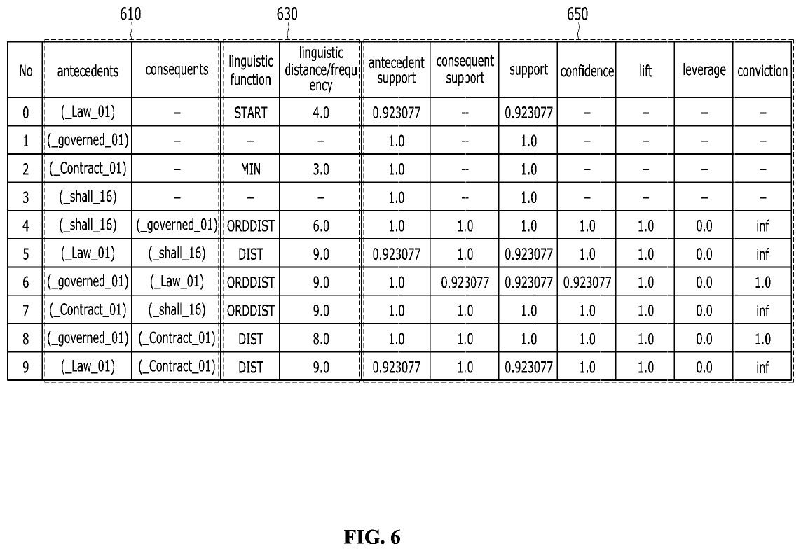

The output unit 140 according to an exemplary embodiment of the present disclosure may display a user interface (UI) capable of receiving a first user input or a second user input for one or more language rules from the user. The output unit 140 may display the user interface illustrated in FIGS. 6 to 8. The user interfaces illustrated in the figures and described above are just examples and the present disclosure is not limited thereto.

The output unit 140 according to an exemplary embodiment of the present disclosure may output any type of information generated or determined by the processor 120 or any type of information received by the network 110.

The output unit 140 according to an exemplary embodiment of the present disclosure may include at least one of a liquid crystal display (LCD), a thin film transistor-liquid crystal display (TFT LCD), an organic light-emitting diode (OLED), a flexible display, and a 3D display. Some display modules among them may be configured as a transparent or light transmissive type to view the outside through the displays. This may be called a transparent display module and a representative example of the transparent display module includes a transparent OLED (TOLED), and the like.

User input may be received through the input unit 150 according to an exemplary embodiment of the present disclosure. The input unit 150 according to an exemplary embodiment of the present disclosure may include keys and/or buttons on the user interface or physical keys and/or buttons for receiving the user input. A computer program for controlling a display according to exemplary embodiments of the present disclosure may be executed according to the user input through the input unit 150.

The input unit 150 according to exemplary embodiments of the present disclosure receives a signal by sensing a button operation or a touch input of the user or receives speech or a motion of the user through a camera or a microphone to convert the received signal, speech, or motion into an input signal. To this end, speech recognition technologies or motion recognition technologies may be used.

The input unit 150 according to exemplary embodiments of the present disclosure may be implemented as external input equipment connected to the computing device 100. For example, the input equipment may be at least one of a touch pad, a touch pen, a keyboard, or a mouse for receiving the user input, but this is just an example and the present disclosure is not limited thereto.

The input unit 150 according to an exemplary embodiment of the present disclosure may recognize user touch input. The input unit 150 according to an exemplary embodiment of the present disclosure may be the same component as the output unit 140. The input unit 150 may be configured as a touch screen implemented to receive selection input of the user. The touch screen may adopt any one scheme of a contact type capacitive scheme, an infrared light detection scheme, a surface ultrasonic wave (SAW) scheme, a piezoelectric scheme, and a resistance film scheme. A detailed description of the touch screen is just an example according to an exemplary embodiment of the present disclosure and various touch screen panels may be adopted in the computing device 100. The input unit 150 configured as the touch screen may include a touch sensor. The touch sensor may be configured to convert a change in pressure applied to a specific portion of the input unit 150 or capacitance generated at the specific portion of the input unit 150 into an electrical input signal. The touch sensor may be configured to detect touch pressure as well as a touched position and area. When there is a touch input for the touch sensor, a signal(s) corresponding to the touch input is(are) sent to a touch controller. The touch controller processes the signal(s) and thereafter, transmits data corresponding thereto to the processor 120. As a result, the processor 120 may recognize which area of the input unit 150 is touched, and the like. According to the present disclosure, the computing device 100 may receive the first user input or the second user input from the user through the input unit 150.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

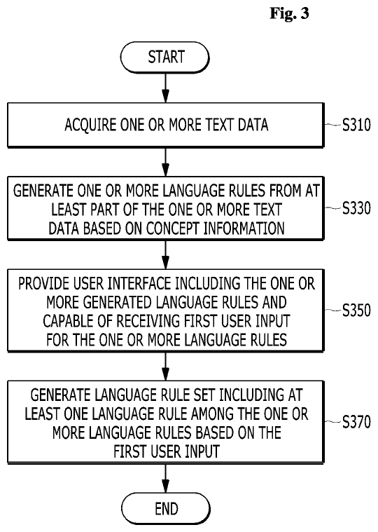

FIG. 3 is a flowchart illustrating a process for generating a language rule set according to an exemplary embodiment of the present disclosure. According to the present disclosure, the computing device 100 may acquire one or more text data in step S310. The computing device 100 may generate one or more language rules from at least some of the one or more text data based on transaction data from one or more text data acquired based on concept information in step S330. The computing device 100 may provide a user interface including the one or more language rules generated in step S350, and capable of receiving the first user input for the one or more language rules from the user. The computing device 100 may generate a language rule set including at least one language rule among the one or more language rules based on the first user input in step S370.

In the present disclosure, “text data” may mean any type of data described as a natural language which may be appreciated by human beings, and may have any length such as a phoneme, a syllable, a word, a sentence, a document, etc. Accordingly, in the present disclosure, a meaning of “one or more text data” should be interpreted as a meaning including one or more phonemes, one or more words, one or more sentences, one or more documents, etc.

In the present disclosure, “concept set” may mean a word set including one or more words. The “word” included in the concept set may also include arbitrary types of texts such as a phrase, a paragraph, a sentence, etc. One or more words included in the concept set may be similar words determined to be similar to each other based on predetermined characteristics. In an exemplary embodiment of the present disclosure, when there is one word included in the concept set, the corresponding word may be determined to be similar only by one. The predetermined characteristics for determining whether the one or more words are similar may include, for example, a semantic similarity, a grammatical similarity, an ideological similarity, a perceptual similarity, etc. The semantic similarity may be, for example, characteristics of a plurality of words having the same or similar meaning, such as “act”, “code”, “law”, “rule”, etc. The grammatical similarity may be, for example, characteristics of a plurality of words which are grammatically modified with respect to the same word, such as “eat”, “ate”, “eat”, “ate”, etc. The ideological similarity may be, for example, characteristics of a plurality of words which frequently appear in actually using the language by transferring a similar feeling or idea to persons, such as “moon”, “rabbit”, etc. The perceptual similarity may be, for example, characteristics shared by a plurality of words which are recognized to be physically positioned in the same space, such as “monitor”, “mouse”, “keyboard”, etc. An example regarding the predetermined characteristics which become a basis of the similarity determination is just an example for the description, but does not limit the present disclosure, and in the present disclosure, the similarity between the plurality of words included in the concept set includes arbitrary characteristics without a limit. In the present disclosure, the “concept” may be used as a term for collecting calling the words included in the “concept set”. For example, “concept A” may be “collective calling of words included in concept set A”.

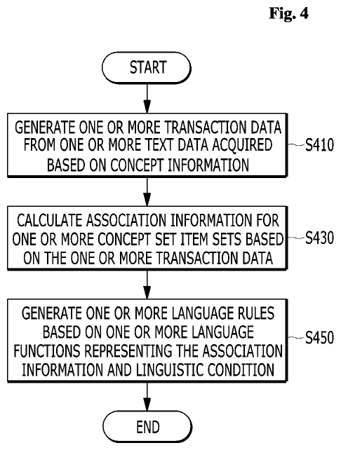

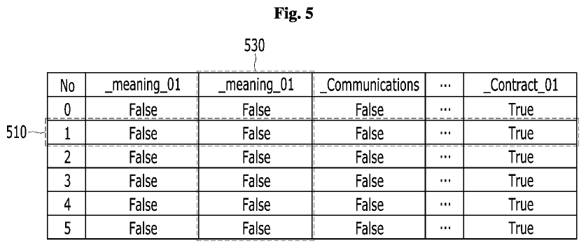

In the present disclosure, “concept information” may mean data including one or more concept sets. In the present disclosure, a method for generating one or more language rules based on the concept information will be described below in detail with reference to FIGS. 4 and 5.

The computing device 100 according to an exemplary embodiment of the present disclosure may classify one or more acquired text data according to one or more topics. The computing device 100 may classify the one or more text data according to one or more topics based on a latent space expression model including at least one node.

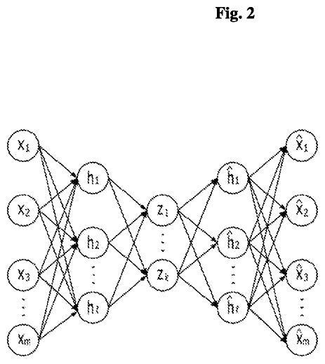

FIG. 2 is a schematic view illustrating a network function according to an exemplary embodiment of the present disclosure. A topic classification for one or more text data according to the present disclosure may be performed by an artificial neural network model including at least one node.

Throughout the present specification, a model, a computation model, the neural network, a network function, and the neural network may be interchangeably used as the same meaning. The neural network may be generally constituted by an aggregate of calculation units which are mutually connected to each other, which may be called nodes. The nodes may also be called neurons. The neural network is configured to include at least one node. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to still another exemplary embodiment of the present disclosure, the number of nodes of the input layer may be larger than the number of nodes of the output layer, and the neural network may be a neural network of a type in which the number of nodes increases from the input layer to the hidden layer. The neural network according to yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

In an exemplary embodiment of the present disclosure, a latent space expression model which the computing device 100 uses for classifying the topic for the text data may include the auto encoder. The auto encoder may be a kind of artificial neural network for outputting output data similar to input data and include one or more hidden layers. The computing device 100 may train the latent space expression model by a method for expressing the text data as a vector, and then inputting the vector into the auto encoder, and reducing an error between an output vector and the input text data vector. After the training is completed, the computing device 100 may acquire a hidden vector output by the hidden layer included in the latent space expression model. The hidden vector as a latent space expression vector for expressing the text data in a latent space may be used by the computing device 100. In the present disclosure, the latent space expression model includes the auto encoder, and uses the hidden vector which is an intermediate output of the auto encoder to reduce a dimension of the text data input vector having a high dimension, thereby reducing a computation amount. Further, the computing device according to the present disclosure uses the latent space expression model including the auto encoder to reduce noise included in the text data and further facilitate clustering. The computing device 100 may calculate an L1 distance, an L2 distance, or a cosine similarity for the hidden vector for the plurality of respective text data, and perform clustering based thereon.

According to an exemplary embodiment of the present disclosure, input data input into the latent space expression model by the processor 120 may include a topic vector for the text data generated based on a topic modeling algorithm or an embedding vector for the text data generated through an embedding model including at least one node. The topic vector may be generated as an application result of LDA, TF-IDF technology, etc. For example, when the topic for the text data is extracted through the LDA technology, a probability for each of K topics which pre-exist may be acquired, and this may be expressed as a vector having a size of K. The computing device 100 may generate the topic vector based on the vector having the K size.

The embedding model including at least one node for generating the embedding vector may receive one or more text data as an input in a training step. The embedding model may mask a token of a predetermined ratio in one or more text data input for unsupervised learning. The token means a unit of the text data including a word, a word segment, or a syllable. The predetermined ratio may be, for example, 30% of a total sentence length. The masking as a task for preventing the corresponding token from being input into the embedding model may be performed by deleting text data contents included in the token. Thereafter, the embedding model may be trained by predicting the masked token and comparing the predicted token and an actual token at a corresponding location to reduce the error. In this process, the embedding model generates an embedding vector for an input sentence. When the training for the embedding model is completed after the above process, the computing device 100 according to the present disclosure may generate the embedding vector based on the embedding model for one or more text data.

The computing device 100 may combine the topic vector and the embedding vector, and use the combined vector as the input data of the latent space expression model. In this case, rather than just expressing the text data input into the model by a method such as a one-hot vector, etc., input data to which characteristics such as the topic, the contents, etc., of the text data are reflected may be generated and this shows an effect of enhancing the performance of the topic classification.

In an exemplary embodiment of the present disclosure, the computing device 100 may classify one or more text data according to one or more topics, and then generate the language rule for each topic. When the language rule is generated based on the text data classified according to the topic as such, a language rule common to a specific topic may be more rapidly and effectively than a case of generating the language rule without the topic classification.

Referring to FIG. 3, a method for generating, by the computing device 100, one or more language rules from at least some of one or more text data based on the concept information in step S330 will be described in detail with reference to FIGS. 4 and 5.

FIG. 4 is a flowchart illustrating a process for generating a language rule according to an exemplary embodiment of the present disclosure. The computing device 100 according to the present disclosure may generate one or more transaction data from one or more text data acquired based on the concept information in step S410. The computing device 100 may check whether one or more concept sets included in the concept information are included in each of one or more text data, and then generate the transaction data. The transaction data may include binary data indicating whether each of one or more concept sets is included for each text.

FIG. 5 is an exemplary diagram of transaction data generated by a computing device according to an exemplary embodiment of the present disclosure. As illustrated in FIG. 5, the transaction data according to the present disclosure may be expressed in a matrix form. In the transaction data expressed in a matrix, each row may include binary data for one or more concept sets for any one text data. In the transaction data expressed in the matrix, each column may include binary data indicating which text data among one or more text data any one concept set is included in. The binary data may indicate whether each concept set is included in the corresponding text data. For example, in the case of reference numeral 510 representing transaction data for text data #1, it may be confirmed that a concept set corresponding to ‘_meaning_01’ does not exist in text data #1 and a concept set corresponding to ‘_Contract_01’ exists in text data #1, through a notation of True or False of the binary data. As such, according to the present disclosure, since the text data is examined and the transaction data is generated at a concept set level constituted one or more similar words other than an individual word level, grouping the transaction data is easy, and as a result, an upper concept representing an implication included in the text data may be more rapidly extracted from the text data.

Referring to FIG. 4, the computing device 100 according to the present disclosure may calculate association information for one or more concept set item sets based on the one or more generated transaction data in step S430.

The “concept set item set” according to an exemplary embodiment of the present disclosure means a set of one more concept sets. For example, when there is concept set A, concept set B, and concept set C, the concept set item set may be configured as A, B, C, (A,B), (B,C), (A,C), or (A,B,C). The concept set item set may also include only one concept set. The number of concept sets which may be included in the concept set item set may be an arbitrary natural number.

The association information according to an exemplary embodiment of the present disclosure may include a value for at least one scale of a support, a confidence, a lift, a leverage, and a conviction. The support may be expressed as in Equation 1.

$$support ( A \to B ) = \frac{n ( A ⋃ B )}{N} \qquad [ Equation 1 ]$$

n(A∪B) represents the number of text data simultaneously including concept sets expressed as A and B in A∪B. N represents the number of all text data. The support may express the number of text data including a word corresponding to a specific concept among one or more text data. When the support for one concept set is calculated, the support may be computed by Equation 2.

$$support ( A ) = \frac{n ( A )}{N} \qquad [ Equation 2 ]$$

n(A) represents the number of data including a word corresponding to concept A among all text data. That is, the support may be calculated even for one concept set.

The confidence according to an exemplary embodiment of the present disclosure may be expressed as in Equation 3.

$$confidence ( A \to B ) = \frac{support ( A \to B )}{support ( A )} \qquad [ Equation 3 ]$$

The confidence may be calculated based on the support according to Equations 1 and 2 above. Since the confidence means a ratio of data including even B among data including concept A, the confidence may include a meaning of a conditional probability. In the case of the confidence, when confidence(A→B) and confidence(B→A) are calculated, a size of a denominator may vary, and as a result, the confidence is an asymmetric scale. With respect to the confidence as one of the scales included in the association information, a feature according to the order of the word in the text may be considered.

The lift according to an exemplary embodiment of the present disclosure may be expressed as in Equation 4.

$$lift ( A \to B ) = \frac{confidence ( A \to B )}{support ( B )} \qquad [ Equation 4 ]$$

The lift may be calculated based on Equations 1 to 3 above. When the lift is 1, concepts A and B may be independent of each other. When the lift is larger than 1, concepts A and B may have a positive correlation with each other. When the lift is smaller than 1, concepts A and B may have a negative correlation with each other. Since it is guaranteed that values of lift(A→B) and lift(B→A) will be continuously equal to each other, the lift is a scale in which an exchange law is established.

The leverage according to an exemplary embodiment of the present disclosure may be expressed as in Equation 5.

lift(A→B)=support(A→B)−support(A)×support(B) [Equation 5]

The conviction according to an exemplary embodiment of the present disclosure may be expressed as in Equation 6.

$$conviction ( A \to B ) = \frac{1 - support ( B )}{1 - confidence ( A \to B )} \qquad [ Equation 6 ]$$

The scales expressed by the above-described equations are just examples for one or more scales included in the association information, but the present disclosure may include various numerical data which may be generated from the transaction data without a limit.

The computing device 100 according to the present disclosure may calculate association information including the scales expressed in Equations 1 to 6 described above in various exemplary embodiments. The computing device 100 according to the present disclosure may calculate the association information, and then select only a concept set item set having a value equal to or more than a threshold for each scale. For example, the computing device 100 may select a concept set item set in which the calculated support value is 0.9 or more. Further, the computing device 100 may also select a concept set item set in which the support value is 0.9 or more and the value of the confidence is also 0.9 or more. The computing device 100 according to the present disclosure may generate one or more language rules based on the association information, and also output the user interface including the association information.

Referring back to FIG. 4, the computing device 100 according to the present disclosure may generate one or more language rule based on the association information and one or more language functions indicating a linguistic condition in step S450. The one or more language functions may include, for example, an AND function meaning an intersection of the concept, an OR function meaning a union of the concept, a distance function (DIST) between the concepts regardless of the order, a distance function (ORDDIST) between the concepts considering the order, a concept emergence frequency function (FREQ), a concept-start point distance function (START), or a concept-end point distance function (END).

The distance function (DIST) between the concepts regardless of the order may require a maximum value for the distance as a function parameter. The maximum value for the distance may be set based on a value input from the user through a second user input, and also set to a default value. The default value may be, for example, 10. The distance function (DIST) between the concepts regardless of the order means a function to search a case where words corresponding two concepts commonly appear in one text data, but is less than the maximum value for the distance. The distance function (ORDDIST) between the concepts considering the order is a function to search a case where a word corresponding to a preceding concept and a word corresponding to a trailing concept are distinguished, and the word is present according to the order, but the word is present to the set maximum distance value or less. The distance function between the concepts considering the order as the function parameter may also require the maximum value for the distance, and the corresponding contents are duplicated with the distance function between the concepts regardless of the order, and as a result, the distance function is omitted.

The concept emergence frequency function (FREQ) may require a minimum frequency as a parameter. The concept emergence frequency function may represent the number of times at which one or more concepts are emerged in the text data. For example, when the minimum frequency is set to 3, if the computing device 100 applies the concept emergence frequency function upon generating the language rule, it may be guaranteed that the generated language rule appears in one or more text data at least three times. The concept emergence frequency function may be used as one of the language functions in order to disregard a rule close to noise which excessively intermittently appears.

The concept-start point distance function (START) or the concept-end point distance function (END) is a language function to search a case where the concept is positioned at a maximum of N distance or less from the start point or end point of the text data. The concept-start point distance function (START) or concept-end point distance function (END) as the function parameter may commonly require a maximum distance. For example, when the concept-start point distance function (START) has 5 as a maximum distance parameter, a text data including an element word of the corresponding concept set may be detected within a fifth order from a first word phrase or word of the text data. The concept-end point distance function (END) performs a similar function, but may be different from the concept-start point distance function (START) in that a reference point is a last word. The concept-start point distance function (START) or concept-end point distance function (END) may be a language function in which important information in the text data generally includes a linguistic background knowledge which appears around the start point of the text data or around the end point of the text data.

The description of the type of language function included in one or more language functions is just an exemplary enumeration and does not limit the present disclosure. According to the present disclosure, one or more language functions indicating the linguistic condition is applied to generate a language rule for finding text data which meets the corresponding condition. For example, when ORDDIST is selected as the language function for the concept set item set including concepts A and B, the language rule may be expressed as (ORDDIST, 9, concept A, concept B). 9 included in the language rule may mean a distance between words corresponding to the concept. The selection of the language function may be performed based on a separate second user input. The language function may also be determined as a predetermined type and a predetermined parameter value by the computing device 100.

Referring to FIG. 3, the computing device 100 may provide a user interface including the one or more language rules generated in step S350, and capable of receiving the first user input for the one or more language rules from the user. Hereinafter, the user interface according to an exemplary embodiment of the present disclosure will be described with reference to FIGS. 6 to 8.

The user interface according to an exemplary embodiment of the present disclosure may include additional information related to one or more language rules. The additional information may include quantitative numerical data for the language rule. The additional information may also include qualitative data for assisting language rule selection by the user. As such, the computing device 100 according to the present disclosure displays the language rule in the user interface and also display additional information for one or more language rules jointly to assist the language rule selection by the user and generation of the language rule set.

According to an exemplary embodiment of the present disclosure, the additional information included in the user interface may include association information for one or more concept set item sets included in one or more language rules or information on a language function which becomes a basis of the generation of the language rule.

FIG. 6 is an exemplary diagram of a user interface according to an exemplary embodiment of the present disclosure. The computing device 100 according to the present disclosure may display the user interface illustrated in the example of FIG. 6 through the output unit 140. The user interface may include a part 610 displaying one or more concept sets included for each of one or more language rules. In a table illustrated by reference numeral 610, ‘antecedents’ represents a preceding concept, and ‘consequents’ represents a trailing concept.

The user interface may include a part 630 displaying the language function. As an exemplary embodiment of the present disclosure, in the part illustrated by reference numeral 630, ‘linguistic function’ may represent the type of language function applied for each language rule. Further, the ‘linguistic distance/frequency’ part may be a name of a column displaying a value acquired according to the type of language function shown in the ‘linguistic function’. For example, when the type of language function is a distance DIST between two concept sets which is regardless of the order or a distance ORDDIST between two concept sets considering the order, a distance value may be included in each ‘linguistic distance/frequency’ part. As another example, when the type of language function is a frequency at which the corresponding language rule emerges in the text data, the frequency may also be included in the ‘linguistic distance/frequency’ part.

The user interface may include a part 650 including association information. The part 650 including the association information may include at least one of the scales included in the association information, such as the support, the confidence, the lift, the leverage, the conviction, etc., for each language rule.

The user confirms various additional information together with the generated language rule through the user interface according to the present disclosure to effectively select one or more language rules, and then generate the language rule set.

The user interface according to an exemplary embodiment of the present disclosure may distinguish and display at least a part of the text data which becomes a base for generating the one or more language rules from another part.

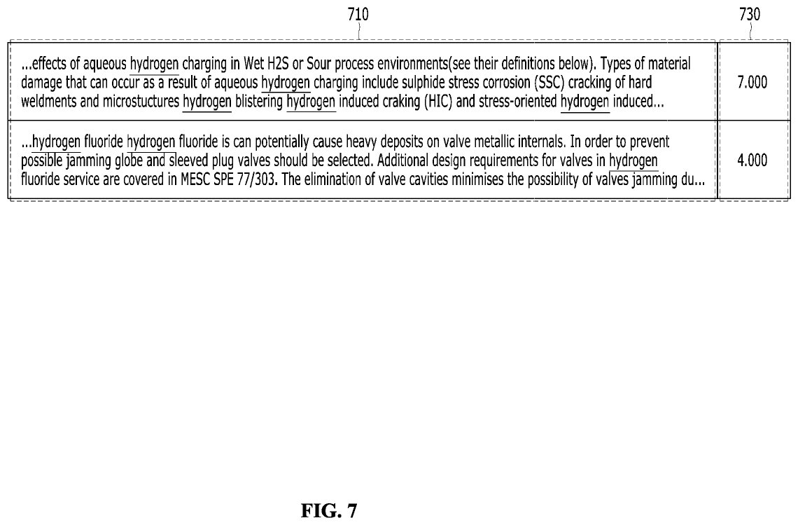

FIG. 7 is another exemplary diagram of a user interface according to an exemplary embodiment of the present disclosure. In an exemplary embodiment of the present disclosure, the user interface may include a part 710 that distinguishes and displays at least a part of the text data which becomes a base for generating the language rule from another text data part. For example, in the case of reference numeral 710, the language rule generated by the processor 120 may include a concept set including a word ‘hydrogen’. In this case, the computing device 100 may distinguish and display the word included in the word (e.g., hydrogen) included in the concept set which becomes the base for generating the corresponding language rule from another text data part by a scheme of underlining the word in the user interface. The computing device 100 may allow words included in the concept set which becomes a base for generating the language rule to have a different color from another text. The computing device 100 may allow the words included in the concept set which becomes a base for generating the language rule to be different from another word for emphasizing a background color. The display method for the distinguishing in the present disclosure is just an example for the description, and the present disclosure includes a display method for distinguishing each word included in one or more concept sets which become a base for generating the language rule from another part in the text data without a limit.

Continuously referring to FIG. 7, in an exemplary embodiment of the present disclosure, the user interface may include a part 730 displaying the emergence frequency of the language rule.

A number included in reference numeral 730 may represent how many times each corresponding language rule emerges on one or more text data.

The user interface according to an exemplary embodiment of the present disclosure may display the language rule set in a tree structure. In the method for analyzing the text according to the present disclosure, the computing device 100 displays the generated language rule set in the tree structure to easily determine a structure among one or more rules included in the language rule set at a glance. As a result, the user interface according to the present disclosure has an effect of making an edition for the language rule set be convenient for the user.

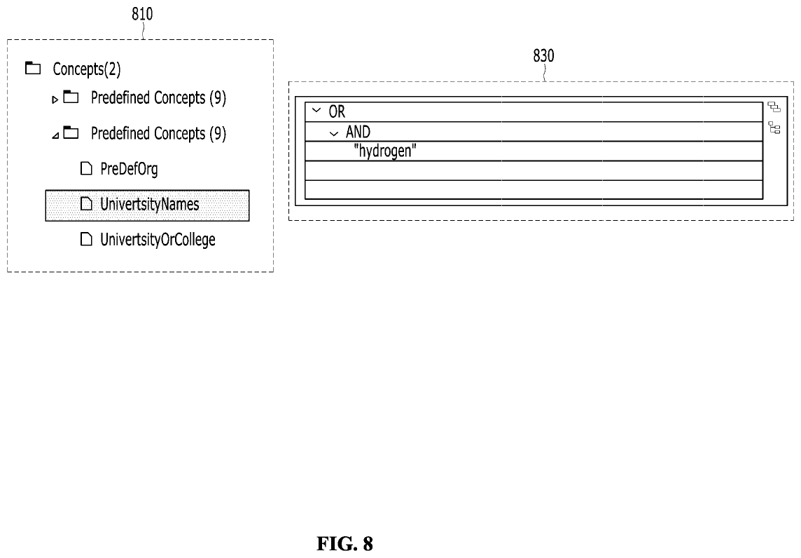

FIG. 8 is still another exemplary diagram of a user interface according to an exemplary embodiment of the present disclosure. The user interface according to the present disclosure may include a part 810 expressing the language rule set in the tree structure. For example, a language rule set ‘Concepts’ may include two sub language rule sets (‘Predefined Concepts’ and ‘Custom Concepts’). Furthermore, a sub language rule set ‘Custom Concepts’ may include language rules such as ‘PreDefOrg’, ‘UniversityNames’, etc., as a lower component again. In the present disclosure, since which language rules are included in one language rule set and which lower language rule set is included are displayed in the user interface in a tree structure form, the user is allowed to easily determine and manage the language rule set.

In an exemplary embodiment of the present disclosure, the user interface may include a part 830 that may edit the language rule. The generated language rule may also be expressed in the tree structure. For example, when the language rule is constituted by (OR, (AND, ‘hydrogen’)), the computing device 100 may express the language rule in a tree structure form having ‘OR’ which is a highest logical operator in the language rule as a parent node and the remaining sub rules as a child node. In the user interface according to the present disclosure, a component such as reference numeral 830 may assist modifying details in the language rule in addition to management for one or more language rules included in the language rule set.

The exemplary diagrams for the user interface illustrated in FIGS. 6 to 8 described above are just examples for the description and do not limit the present disclosure, and the present disclosure includes various types of user interfaces including one or more language rules without a limit.

According to an exemplary embodiment of the present disclosure, the computing device 100 may receive a first user input from the user. The first user input may include binary data for determining whether each language rule included in the one or more generated language rules is to be included the language rule set or logical operator data assigned to each language rule when the one or more generated language rules are included in the language rule set. The binary data may have a value of 0 or 1. The binary data may also have Boolean data of True or False. The computing device 100 may determine whether one or more language rules generated based on the binary data for each language rule included in the first user input are to be included in the existing language rule set. The computing device 100 may set a default value for the binary data to 0 for all language rules. Alternatively, the computing device 100 compares at least one scale in the association information for one or more language rules and a threshold of the corresponding scale to set 1 as the default value only for N higher language rules and set to 0 as the default value for the remaining language rules.

The logical operator data included in the first user input according to an exemplary embodiment of the present disclosure may include, for example, ‘OR’, ‘AND’, ‘NOT’, etc. The logical operator data may be data representing a relationship between a language rule and other language rules to be newly included in the language rule set. For example, when the user inputs ‘OR’ as the logical operator data while selecting any one language rule to be included in the language rule set through the first user input, the corresponding language rule may be defined as a relationship of OR, i.e., ‘or’ with other existing language rules and included in the language rule set. As an example, when one or more language rules are included in the language rule set, the ‘OR’ may set as the default value of the logical operator data assigned to each language rule. As another example, logical operator data ‘NOT’ may be data for setting ‘the corresponding language rule will not exist’ as a condition. For example, when there is excessively a lot of noise in an input document or there is no contribution to analyzing the text data as a sentence or paragraph which exists common to all documents, a language rule generated for the texts needs to be excluded. Accordingly, when the user wants to set excluding the corresponding language rule itself as the condition because a detected frequency is high, but the language rule corresponds to the noise, the user may select ‘NOT’ as the logical operator data while the language rule is included in the language rule set. The description of the logical operator data is just an example and does not limit the present disclosure.

The computing device 100 according to the present disclosure may generate a language rule set including at least one language rule among the one or more language rules generated based on the first user input. In the method for analyzing the text according to the present disclosure, one or more language rules are generated based on the concept information through the computing device 100, but finally, in generating the language rule set, the first user input is received from the user and the language rule set is generated based thereon. Accordingly, the computing device 100 according to the present disclosure may provide a method for generating a specific domain-specific language rule set desired by the user according to the type of text data input by the user, a text application field, etc.

The computing device 100 according to the present disclosure may classify text data input through the language rule set including one or more language rules. Each language rule included in the language rule set may be construed as corresponding to a text classification condition. For example, when the language rule set includes a first language rule (AND, Concept1, Concept2) and a second language rule (ORDDIST, 9, Concept3, Concept4), the computing device 100 may classify text data which satisfy the first and second language rules included in the language rule set among one or more acquired text data. Further, when the language rule set includes one or more language rules in the tree structure, the computing device may additionally classify one or more text data satisfying the first and second language rules into text data satisfying a third language rule and text data not satisfying the third language rule. When the text is classified based on the generated language rule, the user may know a cause of classification of the corresponding text, so there is an advantage in that it is easy to modify the language rule. Further, when the text data is classified based on the language rule set having the tree structure as described above in FIGS. 6 to 8, a distribution or material structure of all text data may be confirmed at a glance, so there is an advantage in that it is easy to structuralize the text data set.

Referring back to FIG. 3, step S330 may further include a step of generating one or more language rules additionally based on the second user input which is input from the user. The computing device 100 according to the present disclosure may receive the second user input even when generating the language rule in addition to the first user input to be considered when generating the language rule set as described above. As a result, the computing device 100 according to the present disclosure intervenes the selection by the user in all processes including the generation of the language rule and the generation of the language rule set to generate a language rule set more specific to a domain.

The second user input according to an exemplary embodiment of the present disclosure may include a threshold for at least one scale included in the association information or a factor for at least one language function among one or more language functions. In the present disclosure, the processor 120 is based on the association information for the content set item set described above in order to generate the language rule, and in this case, the user may set the threshold for at least one scale in the association information. For example, the user may set a threshold of a support included in the association information to 0.9 through the second user input. As another example, the user may set a threshold of a confidence included in the association information to 0.99 through the second user input. As such, the user may receive only a language rule having a predetermined performance or more by setting a performance index lower limit of the language rule to be generated from the language rule generating step through the second user input. As a result, the user may generate an effective language rule set. The second user input includes a factor for at least one language function among one or more language functions. The factor may include the type of language function. The factor may also include, one or more parameters are requested according to the type of language function, a value for a corresponding parameter. The user may designate the type of a language function to be applied to the computing device 100 through the second user input. The type of language function may include at least one of a distance function between words which is regardless of an order, a distance function between words considering the order, a word emergence frequency function, a word-start point distance function, or a word-end point distance function. Further, the user may set a maximum value of the distance between the words simultaneously while setting the distance function between the words as the type of language function. For example, the user may set a maximum distance value to 10 simultaneously while setting the language function to be used for generating the language rule to ORDDIST through the second user input. An example for the second user input is just an example and does not limit the present disclosure.

As such, since the computing device 100 according to the present disclosure receives the second user input from the user and generates one or more language rules based thereon, the computing device 100 may provide a customizing function well fit to the user.

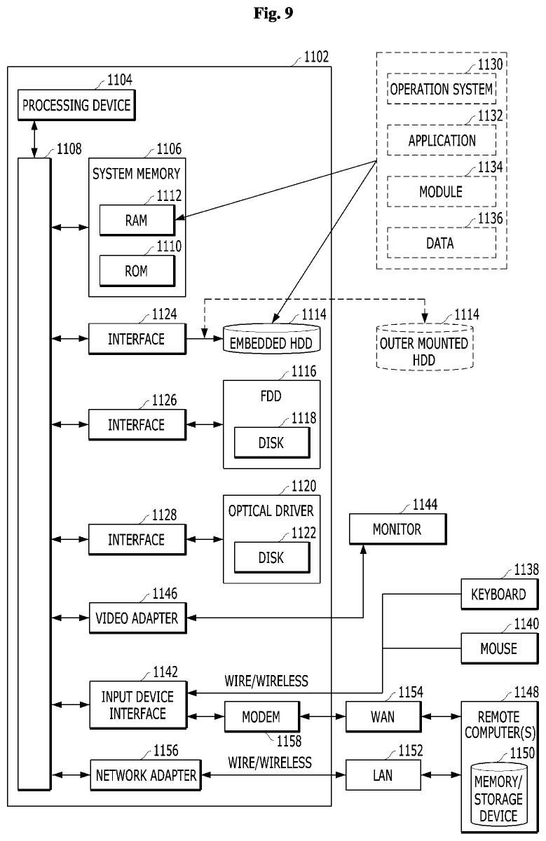

FIG. 9 is a normal and schematic view of an exemplary computing environment in which the exemplary embodiments of the present disclosure may be implemented. It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be interpreted within the widest range which is coherent with the principles and new features presented herein.

What is claimed is:

1. A method for analyzing text data, which is performed by a computing device including at least one processor, the method comprising:
acquiring one or more text data;
generating one or more language rules from at least a part of the one or more text data based on concept information;
providing a user interface including the one or more generated language rules, and capable of receiving a first user input for the one or more language rules from a user; and
generating a language rule set including at least one language rule among the one or more language rules based on the first user input.

2. The method of claim 1, wherein the concept information includes one or more concept sets, but the concept set includes one or more similar words.

3. The method of claim 1, wherein the generating of the one or more language rules includes
generating one or more transaction data from the one or more text data based on the concept information,
calculating association information for one or more concept set item sets based on the one or more transaction data, and
generating one or more language rules based on one or more language functions representing the association information and a linguistic condition.

4. The method of claim 1, wherein the user interface includes additional information related to the one or more language rules.

5. The method of claim 4, wherein the additional information includes
association information for one or more concept set item sets included in the one or more language rules, or
information on a language function which becomes a base for generation of the language rule.

6. The method of claim 1, wherein the user interface distinguishes and displays at least a part of the text data which becomes a base for generating the one or more language rules from another part.

7. The method of claim 1, wherein the user interface displays the language rule set in a tree structure.

8. The method of claim 1, wherein the first user input includes
binary data for determining whether each language rule included in the one or more generated language rules is to be included in a language rule set, or
logical operator data assigned to each language rule when the one or more generated language rules are included in the language rule set.

9. The method of claim 3, further comprising:
generating one or more language rules additionally based on a second user input which is input from a user.

10. The method of claim 9, wherein the second user input includes
a threshold for at least one scale included in the association information, or
a factor for at least one language function among the one or more language functions.

11. A non-transitory computer-readable medium including a computer program, wherein the computer program executes the following operations for analyzing text data when the computer program is executed by one or more processors, the operations comprising:
acquiring one or more text data;
generating one or more language rules from at least a part of the one or more text data based on concept information; and
generating a language rule set including at least one language rule among the one or more generated language rules based on a first user input which is input from a user.

12. An apparatus for analyzing text data, the apparatus comprising:
one or more processors;
a memory; and
a network,
wherein the one or more processors are configured to
acquire one or more text data,
generate one or more language rules from at least a part of the one or more text data based on concept information, and
generate a language rule set including at least one language rule among the one or more generated language rules based on a first user input which is input from a user.
